(19) United States
(12) Patent Application Publication
(10) Pub. No.: US 2011/0095109 A1
(43) Pub. Date: Apr. 28, 2011

(54) Process for Producing Polyester Pellets

(75) Inventors: Georg Borchers, Bad Nauheim (DE); Roman Morschhaeuser, Mainz (DE); Andreas Schottstedt, Hofheim (DE); Mathias Groeschen, Waldbrunn (DE)

(73) Assignee: CLARIANT FINANCE (BVI) LIMITED, Tortola (VG)

(21) Appl. No.: 12/997,932

(22) PCT Filed: Jun. 12, 2009
(86) PCT No.: PCT/EP2009/004231

§ 371 Date: Dec. 23, 2010

(30) Foreign Application Priority Data
Jun. 17, 2008 (DE) 10 2008 028 409.2
Jun. 12, 2009 (EP) PCT/EP2009/004231

(51) Int. Cl. B02C 19/00; B02C 23/00

(52) U.S. Cl. 241/25

(57) ABSTRACT

A process for producing polyester pellets is claimed. This process consists in a) grinding the melt of the polyester, after the production thereof, to a powder with particle sizes of d90,3=10 to 150 mm, and b) processing this powder to pellets with particle sizes of 150 to 1600 mm. The polyester pellets produced by this process are notable for improved solubility at low temperatures

This invention relates to a process for producing polyester pellets having improved solubility in water at low temperatures.

The use of polyesters in laundry detergents to improve soil release off textiles, to reduce resoiling, to protect the fibers from mechanical stress and to endow the fabrics with an anti-crease effect is known. A multiplicity of polyester types and their use in washing and cleaning compositions are described in the patent literature.

U.S. Pat. No. 4,702,857 claims polyesters formed from ethylene glycol, 1,2-propylene glycol or mixtures thereof (1); polyethylene glycol having at least 10 glycol units and capped at one end with a short-chain alkyl group, more particularly with a methyl group (2); a dicarboxylic acid or ester (3); and optionally alkali metal salts of sulfonated aromatic dicarboxylic acids (4).

U.S. Pat. No. 4,427,557 describes polyesters having molecular weights in the range from 2000 to 10 000 g/mol and prepared from the monomers ethylene glycol (1), polyethylene glycol (2) having molecular weights of 200 to 1000 g/mol, aromatic dicarboxylic acids (3) and alkali metal salts of sulfonated aromatic dicarboxylic acids (4) and optionally from small amounts of aliphatic dicarboxylic acids, for example glutaric acid, adipic acid, succinic acid, glutaric acid, pimelic acid, suberic acid, azelaic acid, sebacic acid and 1,4-cyclohexanedicarboxylic acid and advertises their anti-crease effect and soil-release effect on polyester fabrics or on polyester-cotton blend fabrics.

U.S. Pat. No. 4,721,580 discloses polyesters having terephthalate units and sulfo-containing end groups, more particularly sulfoethoxylated end groups MO₃S(CH₂CH₂₀)ₙ—H, and advertises their use in laundry detergents and rinse-cycle fabric conditioners.

U.S. Pat. No. 4,968,451 describes polyesters having sulfo-containing end groups, obtained by copolymerization of (meth)allyl alcohol, alkylene oxide, aryldicarboxylic acid and C₂-C₄ glycol and subsequent sulfonation.

U.S. Pat. No. 5,691,298 claims for use as soil release polymers (SRPs) branched-backbone polyesters formed of di- or polyhydroxysulfonate, terephthalate and 1,2-oxyalkyleneoxy units with nonionic or anionic end groups.

U.S. Pat. No. 5,415,807 discloses that soil release polymers having sulfonated polyethoxy/propoxy end groups tend to crystallize, which results in reduced soil release performance.

Prior art polyesters in solid form are frequently only readily soluble in water at temperatures above 40° C. At lower laundering temperatures, the polyesters dissolve insufficiently, if at all, and partly remain on the laundry as a white residue. In addition, the anti-redeposition action does not take full effect. If, on the other hand, the polymer structure is modified in the direction of better solubility, through the addition of hydrotropes for example, a distinct deterioration in the physical properties is likely to occur and hence simple pelletization is no longer possible.

It is an object of the present invention to provide polyester pellets which are simple to obtain, stable in storage, non-tacky and readily water-soluble at temperatures below 20° C., and provide good soil release.

We have found that this object is achieved, surprisingly, when polyesters comprising units derived from dicarboxylic acids and/or derivatives thereof, from diols and/or from polyols are pelletized by grinding the solidified melt of the polyester after its synthesis into a powder having defined particle sizes and processing this powder into pellets. Particle size or fineness of the ground powder can be defined using the so-called d90,3 value, which can be determined in the course of the determination of particle size distributions. The d90,3 value is to be understood as meaning the particle size which 90% of the particles measured are smaller than. The index 3 characterizes a mass or volume distribution as typically determined by sieve analysis. The present invention seeks a ground fineness for the powder of d90,3=10-150 μm.

The pellets prepared therefrom, by contrast, do not necessarily require an exact definition of fineness. They can be characterized in terms of under- and oversize limits established by a fractionation via sieve cuts for example. A particle size range of about 100-1600 μm results for the typical use of the polyester pellets in cleaning formulations.

The pellets obtained by this process are notable for improved solubility at low temperatures compared with conventionally obtained pellets.

The present invention accordingly provides a process for producing polyester pellets comprising polyesters comprising units derived from dicarboxylic acids and/or derivatives thereof, from diols and/or from polyols, which process comprises
a) grinding the solidified melt of the polyester after synthesis thereof into a powder having particle sizes of d90,3=10 to 150 μm, and
b) processing this powder into pellets having particle sizes of 150-1600 μm.

A preferred embodiment is a process for producing polyester pellets wherein the powder is processed into pellets having particle sizes 200-1500 μm and preferably 250 to 1200 μm.

A further preferred embodiment is a process for producing polyester pellets wherein these have a solubility of 50% to 100% at T<10° C.

A further preferred embodiment is a process for producing polyester pellets wherein these have a dissolving rate of 0.07 g/min to 0.14 g/min at T<10° C. when dissolving 0.7 g of these polyester pellets in 750 ml of water.

A further preferred embodiment is a process for producing polyester pellets wherein polyesters used comprise structural elements
a) derived from di- and/or polycarboxylic acids and/or derivatives thereof selected from:
   aromatic di- and/or polycarboxylic acids and/or their salts and/or their anhydrides and/or their esters,
   aliphatic and cycloaliphatic dicarboxylic acids, their salts, their anhydrides and/or their esters,
   sulfo-containing dicarboxylic acids, their salts, their anhydrides and/or their esters; and
b) derived from diols and
c) derived from polyols and optionally from structural units derived from
d) sulfo-containing acids, optionally
e) from sulfo-containing alcohols, optionally
f) from diol ethers or polyol ethers, optionally
g) from C₁-C₂₄ alcohols or alkoxylated C₁-C₂₄ alcohols.

A further preferred embodiment is a process for producing polyester pellets wherein polyesters used comprise structural elements derived from: terephthalic acid, phthalic acid, isophthalic acid, naphthalenedicarboxylic acid, anthracenedicarboxylic acid, biphenyldicarboxylic acid, terephthalic anhydride, phthalic anhydride, isophthalic anhydride, mono- and dialkyl esters of terephthalic acid, phthalic acid, isophthalic acid with C₁-C₆ alcohols, preferably dimethyl terephthalate, diethyl terephthalate and di-n-propyl terephthalate, polyethylene terephthalate, polypropylene terephthalate, oxalic acid, succinic acid, glutaric acid, adipic acid, fumaric acid, maleic acid, itaconic acid, pimelic acid, suberic acid, azelaic acid, sebacic acid, their anhydrides, and also the mono- and dialkylesters of the carboxylic acids with C₁-C₅ alcohols, for example diethyl oxalate, diethyl succinate, diethyl glutarate, methyl adipate, diethyl adipate, di-n-butyl adipate, ethyl fumarate and dimethyl maleate, 5-sulfoisophthalic acid or its alkali or alkaline earth metal salts, more particularly lithium and sodium salts or mono-, di-, tri- or tetraalkylammonium salts having C₁ to C₂₂ alkyl radicals, mono- and dialkyl esters of 5-sulfoisophthalic acid, 2-naphthyl-dicarboxybenoylsulfonate, 2-naphthyldicarboxybenzenesulfonate, phenyl-dicarboxybenzenesulfonate, 2,6-dimethylphenyl-3,5-benzenesulfonate, phenyl-3,5-dicarboxybenzenesulfonate.

A further preferred embodiment is a process for producing polyester pellets wherein polyesters used comprise structural elements derived from terephthalic acid and/or dialkyl terephthalate, more particularly dimethyl terephthalate.

A further preferred embodiment is a process for producing polyester pellets wherein polyesters used comprise structural elements derived from sulfo-containing dicarboxylic acids their salts, their anhydrides and/or their esters for example, 5-sulfoisophthalic acid or its alkali or alkaline earth metal salts, more particularly lithium and sodium salts or mono-, di-, tri- or tetraalkylammonium salts having C₁ to C₂₂ alkyl radicals, 2-naphthyl-dicarboxybenoylsulfonate, 2-naphthyldicarboxybenzenesulfonate, phenyl-dicarboxybenzenesulfonate, 2,6-dimethylphenyl-3,5-benzenesulfonate, phenyl-3,5-dicarboxybenzenesulfonate.

A further preferred embodiment of the invention is a process for producing polyester pellets comprising polyesters comprising structural elements derived from sulfo-containing acids, preferably 2-hydroxyethanesulfonic acid and sulfobenzoic acid.

A further preferred embodiment is a process for producing polyester pellets wherein polyesters used are capped with end groups, the end groups being derived from a compound according to formula (1) (XO₃S(CHR¹CHR²O)ₙH), where R¹ and R² are each independently hydrogen or an alkyl group having 1 to 4 carbon atoms, preferably hydrogen and/or methyl, X is Li, Na, K, ½Ca or ½Mg and n is from 1 to 50, preferably from 2 to 10.

A further preferred embodiment is a process for producing polyester pellets wherein polyesters used are capped with end groups, the end groups being derived from a compound according to formula (2) (R³O(CHR¹CHR²O )ₙH), where R¹ and R² are each independently hydrogen or an alkyl group having 1 to 4 carbon atoms, preferably hydrogen and/or methyl, R³ is an alkyl group having 1 to 4 carbon atoms and n is from 1 to 50, preferably from 2 to 10 and more preferably from 3 to 6.

A further preferred embodiment is a process for producing polyester pellets wherein polyesters used comprise structural elements derived from: ethylene glycol, 1,2-propylene glycol, 1,2-butylene glycol.

A further preferred embodiment is a process for producing polyester pellets wherein polyesters used comprise structural elements derived from: polyethylene glycols and/or polypropylene glycols having molar masses of 200 to 7000 and preferably 3000 to 6000 g/mol, polymerization products formed from propylene glycol, ethylene glycol and/or butylene glycol in blocks, gradientlike or else in random distribution, having molar masses of 90 to 7000, preferably of 200 to 5000.

A further preferred embodiment is a process for producing polyester pellets wherein polyesters used comprise structural elements derived from: polyols, more particularly glycerol, pentaerythritol, trimethylolethane, trimethylolpropane, 1,2,3-hexanetrol, sorbitol or mannitol.

A further preferred embodiment is a process for producing polyester pellets wherein polyesters used comprise structural elements derived from: C₁-C₂₄ alcohols and alkoxylated C₁-C₂₄ alcohols, more particularly octyl alcohol, decyl alcohol, lauryl alcohol, myristyl alcohol or stearyl alcohol, and the corresponding alkoxylated, more particularly ethoxylated and/or propoxylated, alcohols, alkylphenols, more particularly octylphenol, nonylphenol and dodecylphenol and alkoxylated C₆-C₁₈ alkylphenols, alkylamines, more particularly C₈-C₂₄ monoalkylamines and/or alkoxylated C₈-C₂₄ alkylamines.

A particularly preferred embodiment is a process for producing polyester pellets wherein polyesters used comprise structural elements derived from:
a) one or more nonionic, aromatic dicarboxylic acids or their C₁-C₄ alkyl esters,
b) ethylene glycol,
c) 1,2-propylene glycol,
d) polyethylene glycol having an average molar mass (Mₙ) of 200 to 8000 g/mol,
e) C₁-C₄ alkyl polyalkylene glycol ether having an average molar mass of 200 to 5000 for the polyalkylene glycol ether, and
f) a polyfunctional compound, wherein the molar ratios of components b), c), d), e) and f) based in each case on 1 mol of component a) are from 0.1 to 4 mol for component b), from 0 to 4 mol for component c), from 0 to 0.5 mol for component d), from 0 to 0.5 mol for component e) and from 0 to 0.25 mol for component f).

A further similarly preferred embodiment is a process for producing polyester pellets wherein polyesters used comprise structural elements derived from:
a) one or more nonionic, aromatic dicarboxylic acids or their C₁-C₄ alkyl esters,
b) one or more sulfo-containing dicarboxylic acids or their C₁-C₄ alkyl esters,
c) ethylene glycol,
d) 1,2-propylene glycol,
e) polyethylene glycol having an average molar mass (Mₙ) of 200 to 8000 g/mol,
f) C₁-C₄ alkyl polyalkylene glycol ether having an average molar mass of 200 to 5000 for the polyalkylene glycol ether,
g) one or more compounds of formula (1) (XO₃S(CHR¹CHR²O)ₙH), where R¹ and R² are each independently hydrogen or an alkyl group having 1 to 4 carbon atoms, preferably hydrogen and/or methyl, X is Li, Na, K, ½Ca or ½Mg and n is from 1 to 50, preferably from 2 to 10,
and
h) a polyfunctional compound, wherein the molar ratios of components b), c), d), e), f), g) and h) based in each case on 1 mol of component a) are from 0.1 to 4 mol for component b), from 0 to 4 mol for component c), from 0 to 4 mol for component d), from 0 to 0.5 mol for component e), from 0 to 0.5 mol for component f), from 0 to 0.5 mol for component g) and from 0 to 0.25 mol for component h).

The polyesters used in the process of the present invention are obtained by condensing the monomers in a known manner. The molar quantities of the monomers used and the polymerization conditions are chosen such that the number average molecular weights of the polyesters are in the range from 800 to 25 000 g/mol, more particularly in the range from 1000 to 15 000 g/mol and more preferably in the range from 1200 to 12 000 g/mol. The polyesters used according to the present invention have softening points above 40° C., preferably in the range from 50 to 200° C., more preferably in the range from 80° C. to 150° C. and even more preferably in the range from 100° C. to 120° C.

A preferred embodiment of the invention is a process for producing polyester pellets which are characterized in that the monomers are condensed in the presence of a salt of a C₁-C₃ alkyl carboxylic acid, more particularly a dehydrated or partially hydrated sodium acetate CH₃COONa×(H₂O)ₓ, where x is from 0 to 2.9, wherein the salt of the carboxylic acid in weight amounts of 0.5% to 30%, preferably in the range from 1% to 15% and more preferably in the range from 3% to 8% based on the total amount of the monomers used and the salt of the carboxylic acid.

A further preferred embodiment of the invention is a process for producing polyester pellets which are characterized in that the monomers are condensed in the presence of a salt of a C₁-C₃ alkyl carboxylic acid and one or more further salts selected from toluene-, xylene-, toluenesulfonate, potassium hydrogenphosphate wherein the mixing ratio of carbonate to sulfonate/phosphonate can be in the range from 1 to 99.

The polyesters used in the process of the present invention are obtained, in their as-synthesized state, in the form of a melt which, by cooling in a cool gas stream, for example an air or nitrogen stream, or preferably by application to a flaking roll or to a conveyor belt at 40 to 80° C., preferably at 45 to 55° C., is solidified into flakes. This coarse product is ground into powder having particle sizes d90,3=10 to 150 μm, which can be followed, if necessary, by a sieving operation to remove oversize.

Suitable milling apparatus includes a number of mills which preferably operate by the principle of impact comminution. Conceivable mills thus include, for example, hammer mills, pin mills or jet mills, which are optionally equipped with an integrated sifter to limit the maximum particle size. The fineness of the ground powder can easily be varied by varying typical operating parameters (mill speed, throughput), for example from d90,3=10 μm to d90,3=150 μm. In the course of the grinding operation, the product will heat up as a result of the mechanical input of energy. The temperature of the material being ground should remain below the softening range of about 60-65° C. in order that gunging up and blocking of the mill may be avoided. Depending on mill design, the gas volume stream transported through the mill may in itself be sufficient to provide adequate cooling.

In the process of the present invention, this powder is processed into pellets having particle sizes of about 100-1600 μm.

Several pelletization methods are contemplated:

In a preferred embodiment of the invention, pelletization is effected by compacting the ground powder with and without addition of further additives. Compacting the powder material having particle sizes d90,3=10 to 150 μm is preferably done on so-called roll compactors (for example from Hosokawa-Bepex, Alexanderwerk, Köppern). The choice of roll profile makes it possible to produce pieces or briquettes on the one hand and slugs on the other. The compacts are subsequently comminuted in a mill to pellets having the desired particle size of about 100-1600 μm. By way of mill type, it is typical to use preferably gentle milling machines, for example sieve and hammer mills (for example from Hosokawa-Alpine, Hosokawa-Bepex) or roll stands (for example from Bauermeister, Bühler).

The pellet material thus produced is sieved to remove the undersize fraction and, if present, the oversize fraction. The oversize fraction is recycled to the mill and the undersize fraction is recycled to the compacting stage. The pellets can be classified using, for example, sieving machines from Allgaier, Sweco, Rhewum.

In a further preferred embodiment of the invention, pelletization proceeds from ground powder of defined fineness and takes the form of a build-up pelletization in a mixer. The pelletization of the polyesters, more particularly the pelletization of the polyesters with additives, can take place in customary, batch or continuous mixing devices which are generally equipped with rotating mixing elements. The mixers used can be moderate-intensity mixers such as, for example, plowshare mixers (Lödige KM types, Drais K-T types) but also high-intensity mixers (e.g., Eirich, Schugi, Lödige CB types, Drais K-TT types). In a preferred embodiment, polyesters and additives are mixed concurrently. However, it is not difficult to conceive of multi-stage mixing operations wherein the polyesters and additives are incorporated into the overall mixture in various combinations individually or together with further additives. The sequence of slow-speed and high-speed mixers can be swapped round, if desired. The residence times in mixer pelletization are preferably 0.5 s to 20 min and more preferably 2 s to 10 min.

Depending on the additives used (solvent-containing or in the form of a melt) the pelletization stage is followed by a drying step (for solvents) or a cooling step (for melts) to avoid sticking together of the pellets. The aftertreatment preferably takes place in a moving bed apparatus. Thereafter, the oversize and undersize fractions are sieved out of the target pellets having particle sizes of about 100-1600 μm. The oversize fraction is comminuted by grinding and is like the undersize fraction also sent into a renewed pelletizing operation.

In a further embodiment of the invention, pelletization takes the form of shaping pelletization. The ground polyester powder is admixed with an additive, so that the mixture is present in homogeneous form as a plastifiable mass. The mixing step can take place in the abovementioned mixing machines, but kneaders or specific types of extruders (for example Extrud-o-mix from Hosokawa-Bepex Corp.) are also conceivable. The mass to be pelletized is subsequently forced by means of tools through the die holes in a molding press to form cylindrically shaped extrudates. Suitable machines for the extrusion are preferably annular edge-run presses (for example from Schlüter) or edge runners (for example from Amandus-Kahl), optionally also extruders embodied as a single-screw machine (for example from Hosokawa-Bepex, Fjui-Paudal) or preferably as a twin-screw extruder (for example from Handle). The choice of diameter for the die hole depends on the individual case and is typically in the range of 0.7-4 mm.

Useful additives are preferably water-free products, such as fatty alcohols, C₈-C₃₁ fatty alcohol polyalkoxylates with 1 to 100 mol of EO), C₈-C₃₁ fatty acids (for example lauric acid, myristic acid, stearic acid), dicarboxylic acids, for example glutaric acid, adipic acid or anhydrides thereof, anionic or nonionic surfactants, waxes, silicones, anionic and cationic polymers, homo-, co- and graft copolymers of unsaturated carboxylic acids and/or sulfonic acids and also alkali metal salts thereof, cellulose ethers, starch, starch ethers, polyvinylpyrrolidone); mono- or polyhydric carboxylic acids, hydroxy carboxylic acids or ether carboxylic acids having 3 to 8 carbon atoms and also their salts and polyalkylene glycols. Useful polyalkylene glycols include polyethylene glycols, 1,2-polypropylene glycols and also modified polyethylene glycols and polypropylene glycols. Modified polyalkylene glycols include more particularly sulfates and/or disulfates of polyethylene glycols or polypropylene glycols having a relative molecular mass between 600 and 12 000 and more particularly between 1000 and 4000. A further group consists of mono- and/or disuccinates of polyalkylene glycols, which in turn have relative molecular masses between 600 and 6000 and preferably between 1000 and 4000. Ethoxylated derivatives such as trimethylolpropane with 5 to 30 EO are also encompassed.

The polyethylene glycols used with preference can have a linear or branched structure, in which case linear polyethylene glycols are preferred in particular. The particularly preferred polyethylene glycols include those having relative molecular masses between 2000 and 12 000, advantageously around 4000, in which case polyethylene glycols having relative molecular masses below 3500 and above 5000 can be used particularly in combination with polyethylene glycols having a relative molecular mass around 4000, and such combinations can advantageously include up to more than 50%, based on the total amount of the polyethylene glycols, of polyethylene glycols having a relative molecular mass between 3500 and 5000.

Modified polyethylene glycols further include one- or multi-sidedly end group capped polyethylene glycols wherein the end groups preferably are C₁-C₁₂ alkyl chains, preferably C₁-C₆, which can be linear or branched. One-sidedly end group capped polyethylene glycol derivatives may also conform to the formula Cx(EO)y(PO)z, where Cx can be an alkyl chain having a carbon chain length of 1 to 20, y 50 to 500 and z 0 to 20. It is similarly possible to use low molecular weight polyvinylpyrrolidones and derivatives thereof having relative molecular masses up to not more than 30 000. Preference here is given to relative molecular mass ranges between 3000 and 30 000. Polyvinyl alcohols are preferably used in combination with polyethylene glycols.

The additives can be used, depending on their chemical properties, in solid form, as a melt or as aqueous solutions.

The polyester pellets obtained by the process of the present invention may comprise 0% to 30% by weight of one or more additives, preferably 0% to 25% by weight and more preferably 0% to 20% by weight, based on the polyester pellet.

The polyester pellets obtained according to the invention are directly useful in washing and cleaning compositions. However, in a further form of use, they can be provided with a coating envelope in a conventional manner. To this end, the polyester pellet is enveloped, in an additional step, with a film-forming substance, and this can have an appreciable influence on the product properties. Useful coatings include any film-forming substances such as waxes, silicones, fatty acids, fatty alcohols, soaps, anionic surfactants, nonionic surfactants, cationic surfactants, anionic and cationic polymers, polyethylene glycols and also polyalkylene glycols.

Contemplated are C₈-C₃₁ fatty acids (for example lauric acid, myristic acid, stearic acid), dicarboxylic acids, for example glutaric acid, adipic acid or anhydrides thereof; phosphonic acids, optionally phosphonic acids in admixture with other customary coatings, more particularly fatty acids, for example stearic acid, C₈-C₃₁ fatty alcohols; polyalkenyl glycols (for example polyethylene glycols having a molar mass of 1000 to 50 000 g/mol); nonionics (for example C₈-C₃₁ fatty alcohol polyalkoxylates with 1 to 100 mol of EO); anionics (for example alkanesulfonates, alkylbenzenesulfonates, α-olefinsulfonates, alkyl sulfates, alkyl ether sulfates with C₈-C₃₁ hydrocarbyl radicals; polymers (for example polyvinyl alcohols); waxes (for example montan waxes, paraffin waxes, ester waxes, polyolefin waxes); silicones.

The meltable coating substance may further include, in dissolved or suspended form, substances that do not soften or melt in this temperature range, examples being polymers (e.g., homo-, co- or graft copolymers of unsaturated carboxylic acids and/or sulfonic acids and also alkali metal salts thereof, cellulose ethers, starch, starch ethers, polyvinylpyrrolidone); organic substances (for example mono- or polybasic carboxylic acids, hydroxy carboxylic acids or ether carboxylic acids having 3 to 8 carbon atoms and also their salts); dyes; inorganic substances (for example silicates, carbonates, bicarbonates, sulfates, phosphates, phosphonates).

Depending on the properties desired for the coated polyester pellet, the coating substance may comprise from 1% to 30% by weight and preferably from 5% to 15% by weight, based on the coated polyester pellet.

The enveloping substances can be applied using mixers (mechanically induced fluidized bed) and fluidized-bed apparatuses (pneumatically induced fluidized bed). Useful mixers include for example plowshare mixers (continuous and batch), annular layer mixers or else Schugi mixers. When a mixer is used, the heat conditioning can take place in a pellet preheater and/or in the mixer directly and/or in a moving bed attached to the mixer on its downstream side. To cool the coated pellet, pellet coolers and/or moving bed coolers can be used. In the case of fluidized bed apparatuses, the heat conditioning is effected via the hot gas used for the fluidizing. The fluidized bed process coated pellet can be cooled similarly to the mixer process via a pellet cooler or a moving bed cooler. In both the mixer process and the fluidized bed process, the coating substance can be applied via a single-material or a two-material spraying device.

The heat conditioning consists in a heat treatment at a temperature of 30 to 100° C., but not above the melting or softening temperature of the respective enveloping substance. Preference is given to using a temperature just below the melting or softening temperature.

The polyester pellets obtained by the process of the present invention have powder flowability when stored normally and do not exhibit any tackiness whatsoever.

The polyester pellets obtained by the process of the present invention are notable for good dissolving at low laundering temperatures. The polyesters equip the textile fibers with significantly improved soil release properties and augment the oily, fatty or pigmentary soil release performance of the other constituents of the laundry detergent.

It can further be advantageous to use the polyesters of the present invention in aftertreating compositions for laundry, for example in a rinse cycle fabric conditioner. Polyester in hard-surface cleaners endows the treated surfaces with a soil-repellent finish.

The present invention accordingly further provides for the use of the polyester pellets obtained by the process of the present invention in washing and cleaning compositions.

The washing and cleaning formulations in which the polyester pellets can be used are pulverulent, granular, pasty, gellike or liquid.

Examples thereof are fully built laundry detergents, mild-action laundry detergents, color laundry detergents, wool laundry detergents, net curtain laundry detergents, modular laundry detergents, laundering tablets, bar soaps, stain salts, laundry starches and stiffeners, ironing aids.

The polyester pellets of the present invention can also be incorporated in household cleaners, for example all-purpose cleaners, dishwashing detergents, carpet cleaning and impregnating compositions, cleaning and care agents for floors and other hard surfaces, for example of plastic, ceramic, glass of the nanotechnology-coated surfaces.

Examples of technical cleaners are plastics cleaners and reconditioners, for example for housings and dashboards, and cleaners and reconditioners for painted surfaces such as automotive bodywork for example.

The washing, reconditioning and cleaning formulations of the present invention contain at least 0.1% by weight, preferably between 0.1% and 10% by weight and more preferably 0.2% to 3% by weight of the polyester pellets of the present invention, based on the final formulations.

Depending on their intended use, the formulations must be adapted in their makeup to the nature of the textiles to be treated or washed or of the surfaces to be cleaned.

The washing and cleaning compositions of the present invention may contain customary ingredients, such as surfactants, emulsifiers, builders, bleach catalysts and activators, sequestrants, soil antiredeposition agents, dye transfer inhibitors, dye fixatives, enzymes, optical brighteners, softening component. However, formulations or parts of the formulation within the meaning of the present invention can be specifically colored and/or perfumed by means of colorants and/or fragrances.

The examples which follow are intended to more particularly elucidate the subject matter of the invention without limiting it to the examples.

### EXAMPLES

Anionic Polyesters 1 to 9

Polyester 1

A 2 l four-neck flask equipped with KPG stirrer, internal thermometer, gas inlet tube and distillation bridge was initially charged with 281.5 g of 1,2-propanediol, 229.6 g of ethylene glycol, 250 g of PEG 250 monomethyl ether, 970.9 g of dimethyl terephthalate and 236.98 g of dimethyl 5-sulfoisophthalate sodium salt, and the reaction mixture was subsequently inertized by passing N₂ into it. Next 1 g of titanium tetraisopropoxide and 0.8 g of sodium acetate were added to the reaction mixture in countercurrent. The mixture was gradually heated up on an oil bath with the solid components starting to melt from about 120-150° C. internal temperature. The mixture was then heated to 190° C. over 30 min with stirring. At about 173° C., the transesterification/distillation began. In the course of 2 h the internal temperature was raised to 210° C. until the stoichiometrically required amount of condensate was reached. Thereafter, the oil bath temperature was raised to about 240-250° C. and the internal pressure was reduced over 30 minutes to the best oil pump vacuum. During the three-hour vacuum phase, the condensation was completed by distilling off the excess quantity of alcohol. During this period, the internal temperature of the polyester melt gradually rose to about 220° C. at the end of the reaction. The flask was then vented with N₂ and the melt was discharged onto metal trays.

Polyester 2

A 3 l four-neck flask equipped with KPG stirrer, internal thermometer, gas inlet tube and distillation bridge was initially charged with 418.5 g of 1,2-propanediol, 279.3 g of ethylene glycol, 212.4 g of tetraethylene glycol monomethyl ether, 1359.3 g of dimethyl terephthalate and 296.22 g of dimethyl 5-sulfoisophthalate sodium salt and 250 g of polyethylene glycol 250, and the reaction mixture was subsequently inertized by passing N₂ into it. Next 1.5 g of sodium methoxide and 0.5 g of sodium carbonate were added to the reaction mixture in countercurrent. The mixture was gradually heated up on an oil bath with the solid components starting to melt from about 120-150° C. internal temperature. The mixture was then heated to 190° C. over 30 min with stirring. At about 173° C., the transesterification/distillation began. In the course of 2 h the internal temperature was raised to 210° C. until the stoichiometrically required amount of condensate was reached. Thereafter, the oil bath temperature was raised to about 240-250° C. and the internal pressure was reduced over 30 minutes to the best oil pump vacuum. During the three-hour vacuum phase, the condensation was completed by distilling off the excess quantity of alcohol. During this period, the internal temperature of the polyester melt gradually rose to about 220° C. at the end of the reaction. The flask was then vented with N₂ and the melt was discharged onto metal trays.

Polyester 3

A 3 l four-neck flask equipped with KPG stirrer, internal thermometer, gas inlet tube and distillation bridge was initially charged with 330 g of 1,2-propanediol, 202 g of ethylene glycol, 145.8 g of tetraethylene glycol monomethyl ether, 582.5 g of dimethyl terephthalate and 296.22 g of dimethyl 5-sulfoisophthalate sodium salt and the reaction mixture was subsequently inertized by passing N₂ into it. Next 1.02 g of titanium tetraisopropoxide and 0.8 g of sodium acetate were added to the reaction mixture in countercurrent. The mixture was gradually heated up on an oil bath with the solid components starting to melt from about 120-150° C. internal temperature. The mixture was then heated to 195° C. over 45 min with stirring. At about 173° C., the transesterification/distillation began. In the course of 3 h the internal temperature was raised to 210° C. until the stoichiometrically required amount of condensate was reached. Thereafter, the oil bath temperature was raised to about 240-255° C. and the internal pressure was reduced over 60 minutes to <20 mbar. During the four-hour vacuum phase, the condensation was completed by distilling off the excess quantity of alcohol. During this period, the internal temperature of the polyester melt gradually rose to about 225° C. at the end of the reaction. The flask was then vented with N₂ and the melt was discharged onto metal trays.

Polyester 4

### Reaction Procedure as Per Example 2

Components: 281.5 g of 1,2-propanediol
223.4 g of ethylene glycol
776.7 g of dimethyl terephthalate
355.5 g of dimethyl 5-sulfoisophthalate sodium salt
295.5 g of tallow fat alcohol with 8 units of ethylene oxide (Genapol T080)
1.0 g of titanium tetraisopropoxide
0.8 g of sodium acetate

Polyester 5

### Reaction Procedure as Per Example 3

Components: 620.6 g of ethylene glycol
970.9 g of dimethyl terephthalate
444.3 g of dimethyl 5-sulfoisophthalate sodium salt
162 g of triethylene glycol monobutyl ether
1.0 g of titanium tetraisopropoxide
0.8 g of sodium acetate

Polyester 6

### Reaction Procedure as Per Example 1

Components: 152.2 g of 1,2-propanediol
124.1 g of ethylene glycol
388.3 g of dimethyl terephthalate
177.7 g of 5-sulfoisophthalic acid lithium salt
100 g of lauryl alcohol with 7 units of ethylene oxide (Genapol LA 070)
1.0 g of titanium tetraisopropoxide

Polyester 7

### Reaction Procedure as Per Example 1

Components: 422.3 g of 1,2-propanediol
335.1 g of ethylene glycol
873.8 g of dimethyl terephthalate
177.7 g of 5-sulfoisophthalic acid sodium salt
100 g of triethylene glycol monomethyl ether
50 g of polyethylene glycol 500
50 g of polyethylene glycol 1500
1.0 g of titanium tetraisopropoxide

Polyester 8

### Reaction Procedure as Per Example 1

Components: 380.5 g of 1,2-propanediol

186.2 g of ethylene glycol

873.8 g of dimethyl terephthalate

444.3 g of 5-sulfoisophthalic acid sodium salt

125 g of tripropylene glycol monomethyl ether

150 g of ethylene oxide-propylene oxide copolymer (Genapol PF 20)
1.0 g of titanium tetraisopropoxide

Polyester 9, Partially End Group Capped with Sulfone Groups

Reaction procedure and components similar to example 3 except that 50 mol% of triethylene glycol monomethyl ether was replaced by the sodium salt of isethionic acid.

Nonionic Polyesters 10 to 18

TABLE 1
Starting materials and amounts used thereof to prepare polyesters
10 to 18

| Starting | Polyester | Polyester | Polyester | | | | | | |
|---|---|---|---|---|---|---|---|---|---|
| material | 10 | 11 | 12 | Polyester 13 | Polyester 14 | Polyester 15 | Polyester 16 | Polyester 17 | Polyester 18 |
| DT/mol | 0.7 | 0.5 | 0.15 | 0.25 | 0.16 | 0.25 | 1 | 0.16 | 0.16 |
| EG/mol | 1.35 | 0.28 | 0.3 | 0.48 | 0.3 | 0.48 | 0.6 | 0.3 | 0.3 |
| PG/mol | — | 0.68 | — | — | — | — | 1.4 | — | — |
| PEG type | 6000 | 6000 | 6000 | 4000 | 6000/ | 3000 | 1500 | 6000 | 6000 |
| | | | | | 200 | | | | |
| PEG/mol | 0.18 | 0.13 | 0.04 | 0.065 | 0.04/ | 0.07 | 0.26 | 0.04 | 0.04 |
| | | | | | 0.004 | | | | |
| MPEG | — | 750/ | 750/ | 750/ | — | — | 750/ | — | — |
| type | | 2000 | 2000 | 2000 | | | 2000 | | |
| MPEG/mol | — | 0.05/ | 0.015/ | 0.024/ | — | — | 0.1/ | — | — |
| | | 0.02 | 0.007 | 0.011 | | | 0.05 | | |
| IPT | 0.0007 | 0.0005 | 0.0001 | 0.0002 | 0.00016 | 0.0002 | 0.001 | 0.0002 | 0.0015 |
| NaOAc | 0.004 | 0.006 | 0.0009 | 0.0015 | 0.0009 | 0.0015 | 0.006 | 0.0009 | 0.0002 |
| PFV type | — | — | — | — | — | — | — | A | B |
| PFV/mol | — | — | — | — | — | — | — | 0.01 | 0.0015 |

A 2,2-bis(hydroxymethyl)propionic acid
B pentaerythritol
DMT dimethyl terephthalate
EG 1,2-ethanediol
PG 1,2-propanediol
PEG polyethylene glycol (200, 1500, 3000, 4000, 6000)
IPT titanium tetraisopropoxide
NaOAc sodium acetate
PVF polyfunctional compounds
MPEG methyl polyglycols

General Method of Synthesizing Nonionic Polyesters 10 to 18

A 2 L four-neck flask equipped with KPG stirrer, internal thermometer, Vigreux column, distillation bridge and Anschütz-Thiele adapter was initially charged with the starting materials dimethyl terephthalate (DMT), 1,2-ethanediol (EG) and/or 1,2-propanediol (PG) and anhydrous sodium acetate (NaOAc) (amounts see Table 1).

The mixture was gradually heated on an oil bath until it had completely melted at about 125° C. Starting at about 130° C., the transesterification ensued, and methanol distilled off. About 15 minutes after the start of the distillation, titanium tetraisopropoxide (IPT) was added at a temperature of 160° C. After a total of about 2 hours, the transesterification was discontinued at 200° C. and the oil bath was lowered.

Then, the corresponding polyethylene glycols (PEG), methyl polyglycols (MPEG) and, where appropriate, polyfunctional compounds (PFV) were added (amounts see Table 1) to the melt and heating was continued up to about 215° C. Thereafter, vacuum was applied and lowered to about 10 mbar over 30 minutes. This was followed by postcondensation at 215° C./10 mbar for about one further hour, during which the amount of distillate generated decreased markedly. Finally, the oil bath was lowered, the apparatus was separated from the vacuum and vented with nitrogen. The melt was discharged while still hot.

These polyester pellets were ground and pelletized and the pellets were tested for solubility at 5° C. and 20° C. and compared in their dissolving rate with conventionally produced polyester pellets.

Investigation of Dissolving Behavior:

750 ml of water were placed in an 800 ml glass beaker and temperature controlled to the desired test temperature (e.g., T=20° C. or T=10° C.) with continuous stirring. To simulate an alkaline wash liquor, the water was adjusted to a pH of about 10-11 by addition of aqueous sodium hydroxide solution.

The sample of the pellet material to be tested was first adjusted to a particle size of 400-1250 μm by passing through sieves, and then a 0.6-0.7 g quantity thereof was weighed out. This portion was transferred into a stirred washing liquor and allowed to dissolve for a timed 5 min. Thereafter, the liquor was filtered through a suction filter equipped with a white ribbon filter. Any product residues on the glass wall were rinsed off with ion-free water onto the filter. The filter paper was dried in a drying cabinet and then the filter residue was determined gravimetrically. From that, the proportion of the original weight of the sample that had dissolved was computed (no weighable residue=100% solubility; complete sample quantity on filter paper=0% solubility).

Pellets Without Additives

Samples of the solidified melt of the polyester according to Example 3 were first ground to produce powders having different degrees of fineness. Their fineness of grind was in each case characterized via the d90,3 value which was determined on measuring the particle size distribution using laser diffraction (Malvern Mastersizer). Thereafter, the ground powder was processed by dry compacting—and without addition of further additives—into pellets in the particle size of 400-1250 μm. For comparison, the solidified polyester melt was directly converted into a pellet material by grinding/sieving, without prior fine grinding.

The test pellets were subsequently subjected to the dissolving test described above and characterized in respect of their dissolving behavior.

The results of the dissolving tests at T=5° C. are summarized in the following table:

| | Fineness of grind | |
|---|---|---|
| Grinding | d90.3/μm | Solubility (T = 5° C.) % |
| Impact mill | 17.6 | 99.8 |
| Impact mill | 40.7 | 73.5 |
| Impact mill | 83.8 | 46.7 |
| Mortar | not determined | 12.6 |
| Ground pellet | no pregrinding | 9.6 |

The results clearly reveal that controlled adjustment of the fineness of grind prior to pelletization can significantly influence and improve the cold-water solubility of the polyester pellets.

### Example 2

### Pellets with Additives

Samples of the solidified melt of the polyester according to Example 3 were first ground to produce powders having different degrees of fineness. Their fineness of grind was in each case characterized via the d90,3 value which was determined on measuring the particle size distribution using laser diffraction (Malvern Mastersizer). Thereafter, the ground powder was processed by dry compacting—once with and once without addition of 20% of PEG 6000 (based on the total amount)—into pellets in the particle size of 400-1250 μm. For comparison, the solidified polyester melt was directly converted into a pellet material by grinding/sieving, without prior fine grinding.

The results of the dissolving tests at T=5° C. are summarized in the following table:

| | Fineness of grind | |
|---|---|---|
| Sample | d90.3/μm | Solubility (T = 5° C.) % |
| Reference without PEG | 134.7 | 65.5 |
| +20% of PEG 6000 | 134.7 | 66.7 |
| Ground pellet | no pregrinding | 2.7 |

These results similarly show that the controlled pregrinding of the polyester makes it possible to achieve a distinct improvement in solubility. The addition of the additive has no adverse consequences.

1. A process for producing polyester pellets, wherein the polyester comprises units derived from dicarboxylic acids and/or derivatives thereof, from diols and/or from polyols, wherein the process comprises the steps of:
a) grinding the solidified melt of the polyester into a powder having particle sizes of d90,3=10 to 150 μm, and
b) processing this powder into pellets having particle sizes of 150-1600 μm.

2. A process according to claim 1, wherein the powder is processed into pellets having particle sizes 200-1500 μm.

3. A process according to claim 1, wherein the polyester comprises structural elements derived from
a) di- and/or polycarboxylic acids and/or derivatives thereof selected from:
aromatic di- and/or polycarboxylic acids and/or their salts and/or their anhydrides and/or their esters,
aliphatic and cycloaliphatic dicarboxylic acids, their salts, their anhydrides and/or their esters,
sulfo-containing dicarboxylic acids, their salts, their anhydrides and/or their esters; and
b) diols and
c) polyols and optionally from structural units derived from
d) sulfo-containing acids, optionally
e) from sulfo-containing alcohols, optionally
f) from diol ethers or polyol ethers, optionally
g) from C₁-C₂₄ alcohols or alkoxylated C₁-C₂₄ alcohols.

4. A process according to claim 1, wherein the polyester comprises structural elements derived from:
terephthalic acid, phthalic acid, isophthalic acid, naphthalenedicarboxylic acid, anthracenedicarboxylic acid, biphenyldicarboxylic acid, terephthalic anhydride, phthalic anhydride, isophthalic anhydride, mono- and dialkyl esters of terephthalic acid, phthalic acid, isophthalic acid, oxalic acid, succinic acid, glutaric acid, adipic acid, fumaric acid, maleic acid, itaconic acid, pimelic acid, suberic acid, azelaic acid, sebacic acid, 5-sulfoisophthalic acid, 2-naphthyldicarboxybenzoylsulfonate, 2-naphthyldicarboxybenzenesulfonate, phenyldicarboxybenzenesulfonate, 2,6-dimethylphenyl-3,5-benzenesulfonate, phenyl-3,5-dicarboxybenzenesulfonate.

5. A process according to claim 4, wherein the polyester comprises structural elements derived from terephthalic acid.

6. A process according to claim 4, wherein the polyester comprises structural elements derived from sulfo-containing acids.

7. A process according to claim 1, wherein the polyester is capped with end groups, the end groups being derived from a compound according to formula (1) (XO₃S(CHR¹CHR²O)ₙH), where R¹ and R² are each independently hydrogen or an alkyl group having 1 to 4 carbon atoms, X is Li, Na, K, ½Ca or ½Mg and n is from 1 to 50.

8. A process according to claim 1, wherein the polyester is capped with end groups, the end groups being derived from a compound according to formula (2) (R³O(CHR¹CHR²O)ₙH), where R¹ and R² are each independently hydrogen or an alkyl group having 1 to 4 carbon atoms, R³ is an alkyl group having 1 to 4 carbon atoms and n is from 1 to 50.

9. A process according to claim 1, wherein the polyester comprises structural elements derived from: ethylene glycol, 1,2-propylene glycol, or 1,2-butylene glycol.

10. A process according to claim 1, wherein the polyester comprises structural elements derived from:
polyethylene glycols and/or polypropylene glycols having molar masses of 200 to 7000, polymerization products formed from propylene glycol, ethylene glycol and/or butylene glycol in blocks, gradientlike or else in random distribution, having molar masses of 90 to 7000 g/mol.

11. A process according to claim 1, wherein the polyester comprises structural elements derived from:
glycerol, pentaerythritol, trimethylolethane, trimethylolpropane, 1,2,3-hexanetriol, sorbitol or mannitol.

12. A process for producing polyester pellets according to claim 1, wherein the polyester comprises structural elements derived from:
C₁-C₂₄ alcohols and alkoxylated C₁-C₂₄ alcohols, and the corresponding alkoxylated, alcohols, alkylphenols, and alkoxylated C₆-C₁₈ alkylphenols, and alkylamines.

13. A process according to claim 1, wherein the polyester comprises structural elements derived from:
a) one or more nonionic, aromatic dicarboxylic acids or their C₁-C₄ alkyl esters,
b) ethylene glycol,
c) 1,2-propylene glycol,
d) polyethylene glycol having an average molar mass (Mₙ) of 200 to 8000 g/mol,
e) C₁-C₄ alkyl polyalkylene glycol ether having an average molar mass of 200 to 5000 for the polyalkylene glycol ether, and
f) a polyfunctional compound,
wherein the molar ratios of components b), c), d), e) and f) based in each case on 1 mol of component a) are from 0.1 to 4 mol for component b), from 0 to 4 mol for component c), from 0 to 0.5 mol for component d), from 0 to 0.5 mol for component e) and from 0 to 0.25 mol for component f).

14. A process according to claim 1, wherein the polyester comprises structural elements derived from:
a) one or more nonionic, aromatic dicarboxylic acids or their C₁-C₄ alkyl esters,
b) one or more sulfo-containing dicarboxylic acids or their C₁-C₄ alkyl esters,
c) ethylene glycol,
d) 1,2-propylene glycol,
e) polyethylene glycol having an average molar mass (Mₙ) of 200 to 8000 g/mol,
f) C₁-C₄ alkyl polyalkylene glycol ether having an average molar mass of 200 to 5000 for the polyalkylene glycol ether,
g) one or more compounds of formula (1) (XO₃S(CHR¹CHR²O)ₙH), where R¹ and R² are each independently hydrogen or an alkyl group having 1 to 4 carbon atoms, preferably hydrogen and/or methyl, X is Li, Na, K, ½Ca or ½Mg and n is from 1 to 50, preferably from 2 to 10,
and
h) a polyfunctional compound,
wherein the molar ratios of components b), c), d), e), f), g) and h) based in each case on 1 mol of component a) are from 0.1 to 4 mol for component b), from 0 to 4 mol for component c), from 0 to 4 mol for component d), from 0 to 0.5 mol for component e), from 0 to 0.5 mol for component f), from 0 to 0.5 mol for component g) and from 0 to 0.25 mol for component h).

15. A process according to claim 1 wherein the powder obtained in step a) is pelletized together with an additive.

16. A process according to claim 1, wherein the powder is processed into pellets having particle sizes of 250 to 1200 μm.

17. A process according to claim 4, wherein the polyester comprises structural elements derived from 2-hydroxyethanesulfonic acid and sulfobenzoic acid.
